(19) United States
(12) Patent Application Publication
(10) Pub. No.: US 2021/0394724 A1
(43) Pub. Date: Dec. 23, 2021

(54) DETECTION OF MODIFIED VEHICLE BODY COMPONENTS FOR AEB RESPONSE

(71) Applicant: SRG GLOBAL, INC., Troy, MI (US)

(72) Inventor: Johanna KINSLER, Troy, MI (US)

(73) Assignee: SRG GLOBAL, INC., Troy, MI (US)

(21) Appl. No.: 17/292,803

(22) PCT Filed: Nov. 12, 2019
(86) PCT No.: PCT/IB2019/059696

§ 371 Date: May 11, 2021

Related U.S. Application Data
(60) Provisional application No. 62/704,032, filed on Nov. 12, 2018.

(51) Int. Cl. B60T 7/22; B60Q 9/00; B60Q 1/30; G06K 9/00; G06K 9/46; G01S 7/41; G01S 13/75; G01S 13/86; G01S 13/931

(52) U.S. Cl. CPC B60T 7/22; B60Q 9/008; B60Q 1/30; G06K 9/00805; G06K 9/4661; G01S 2013/93185; G01S 13/75; G01S 13/867; G01S 13/931; B60T 2201/022; G01S 2013/9316; G01S 7/412

(57) ABSTRACT

A body component of a first vehicle comprises at least one of an integrated retroreflector system configured to reflect radar waves from a second vehicle according to a predefined retroreflective pattern and an integrated light accent system configured to generate and emit light waves according to a defined light pattern. Receipt of at least one of the reflected radar waves and the light waves by the second vehicle causes a controller of the second vehicle to recognize, by accessing a memory database, at least one of the defined retroreflective and light patterns and, in response to recognizing at least one of the defined retroreflective and light patterns, more accurately control an autonomous emergency braking (AEB) system of the second vehicle to thereby improve the performance of the AEB system.

### CROSS-REFERENCE TO RELATED APPLICATIONS

The present application claims the benefit of U.S. Provisional Application No. 62/704,032, filed on Nov. 12, 2018. The disclosure of this application is incorporated herein by reference in its entirety.

### FIELD

The present application generally relates to vehicle autonomous driving and advanced driver assistance (ADAS) systems and, more particularly, to detection of modified vehicle body components for autonomous emergency braking (AEB) system response.

### BACKGROUND

Autonomous driving and advanced driver assistance (ADAS) systems operate in an attempt to avoid undesirable driving scenarios (e.g., collisions). One example feature of these systems is autonomous emergency braking (AEB). An AEB system operates in conjunction with other sensors (radar, cameras, etc.) to autonomously apply a vehicle's brake system when conditions indicate a forward collision is imminent. In some scenarios, however, these sensors may fail to detect objects (e.g., other vehicles). Accordingly, while such autonomous driving and ADAS systems do work well for their intended purpose, an opportunity exists for improvement in the relevant art.

### SUMMARY

According to one aspect of the present disclosure, a body component of a first vehicle is presented. In one exemplary implementation, the body component comprises at least one of: (i) an integrated retroreflector system configured to reflect radar waves from a second vehicle according to a predefined retroreflective pattern, and (ii) an integrated light accent system configured to generate and emit light waves according to a defined light pattern, wherein receipt of at least one of the reflected radar waves and the light waves by the second vehicle causes a controller of the second vehicle to: recognize, by accessing a memory database, at least one of the defined retroreflective and light patterns, and in response to recognizing at least one of the defined retroreflective and light patterns, more accurately control an autonomous emergency braking (AEB) system of the second vehicle to thereby improve the performance of the AEB system.

In some implementations, at least one of the defined retroreflective and light patterns is a higher priority than image-based object detection in decision factor hierarchy of the controller for AEB system control. In some implementations, at least one of the defined retroreflective and light patterns is a higher priority in the decision factor hierarchy of the controller for AEB system control such that, when the controller does not detect the first vehicle in an image captured by a camera of the second vehicle, the controller remains capable of activating the AEB system when at least one of the defined retroreflective and light patterns are recognized.

In some implementations, the improved performance of the AEB system includes an earlier forward collision warning (FCW). In some implementations, the improved performance of the AEB system includes a decreased stopping distance. In some implementations, the light accent system further comprises one or more optical reflectors configured to reflect light according to a defined reflective pattern, the controller is configured to recognize, by accessing the memory database, the defined reflective pattern, and in response to recognizing the defined reflective pattern, more accurately control and thereby improve the performance of the AEB system.

According to another aspect of the present disclosure, a body component for a first vehicle is presented. In one exemplary implementation, the body component comprises: an integrated retroreflector system configured to reflect radar waves from a second vehicle according to a defined retroreflective pattern, and an integrated light accent system configured to generate and emit light waves according to a defined light pattern, wherein receipt of the reflected radar waves and the light waves by the second vehicle causes a controller of the second vehicle to: recognize, by accessing a memory database, the defined retroreflective and light patterns, and in response to recognizing the defined retroreflective and light patterns, more accurately control an AEB system of the second vehicle to thereby improve the performance of the AEB system.

In some implementations, the defined retroreflective and light patterns are higher priorities than image-based object detection in decision factor hierarchy of the controller for AEB system control. In some implementations, the defined retroreflective and light patterns are higher priorities in the decision factor hierarchy of the controller for AEB system control such that, when the controller does not detect the first vehicle in an image captured by a camera of the second vehicle, the controller remains capable of activating the AEB system when the defined retroreflective and light patterns are recognized.

In some implementations, the improved performance of the AEB system includes an earlier FCW. In some implementations, the improved performance of the AEB system includes a decreased stopping distance. In some implementations, the light accent system further comprises one or more optical reflectors configured to reflect light according to a defined reflective pattern, the controller is configured to recognize, by accessing the memory database, the defined reflective pattern, and in response to recognizing the defined reflective pattern, more accurately control and thereby improve the performance of the AEB system.

According to another aspect of the present disclosure, a method of more accurately controlling and thereby improving the performance of an AEB system of a first vehicle is presented. In one exemplary implementation, the method comprises: providing a body component of a second vehicle, the body component comprising at least one of (i) an integrated retroreflector system configured to reflect radar waves from the first vehicle according to a defined retroreflective pattern and (ii) an integrated light accent system configured to generate and emit light waves according to a defined light pattern, and providing a memory database storing information relative to at least one of the defined retroreflective and light patterns, wherein receipt of at least one of the reflected radar waves and the light waves by the first vehicle causes a controller of the first vehicle to: recognize, by accessing the memory database, at least one of the defined retroreflective and light patterns, and in response to recognizing at least one of the defined retroreflective and light patterns, more accurately control and thereby improve the performance of the AEB system.

In some implementation, at least one of the defined retroreflective and light patterns is a higher priority than image-based object detection in decision factor hierarchy of the controller for AEB system control. In some implementations, at least one of the defined retroreflective and light patterns is a higher priority in the decision factor hierarchy of the controller for AEB system control such that, when the controller does not detect the second vehicle in an image captured by a camera of the first vehicle, the controller remains capable of activating the AEB system when at least one of the defined retroreflective and light patterns are recognized.

In some implementations, the improved performance of the AEB system includes an earlier FCW. In some implementations, the improved performance of the AEB system includes a decreased stopping distance. In some implementations, the light accent system further comprises one or more optical reflectors configured to reflect light according to a defined reflective pattern, the controller is configured to recognize, by accessing the memory database, the defined reflective pattern, and in response to recognizing the defined reflective pattern, more accurately control and thereby improve the performance of the AEB system.

In some implementations, the body component of the second vehicle comprises both (i) the integrated retroreflector system and (ii) the integrated light accent system, receipt of the defined retroreflective and light patterns causes the controller to recognize, by accessing the memory database, both the defined retroreflective and light patterns, and in response to recognizing both the defined retroreflective and light patterns, even more accurately control and even further improve the performance of the AEB system. In some implementations, the method further comprises transmitting, by a radar system of the first vehicle, the radar waves reflected by the integrated retroreflector system of the body component of the second vehicle, capturing, by a camera of the first vehicle, an image, and identifying, by the controller, the defined light pattern in the captured image.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 illustrates an overhead view of an example vehicle having a plurality of body components that could include the integrated retroreflector system and/or the integrated light accent system according to some implementations of the present disclosure;

FIG. 2 illustrates a functional block diagram of a first vehicle having a body component with an integrated retroreflector system and/or an integrated light accent system and a second vehicle having an autonomous driving system according to some implementations of the present disclosure;

FIGS. 3A-3B illustrate flow diagrams of example methods of a relating to a first vehicle having a body component with an integrated retroreflector system and/or an integrated light accent system and interaction therewith by a second vehicle having an autonomous driving system according to some implementations of the present disclosure.

### DETAILED DESCRIPTION

As previously mentioned, in some scenarios, conventional vehicle autonomous driving and advanced driver assistance (ADAS) systems can have difficulty detecting objects (e.g., other vehicles). Rather, these conventional systems may struggle to discern between relevant or important objects (e.g., other vehicles) and irrelevant or unimportant objects (e.g., noise). A typical object detection routine involves a combination of radar sensing followed by camera image-based object detection (e.g., using trained models, such as neural networks). One example scenario where object detection is difficult is in low ambient light (i.e., dark) conditions because camera images have less resolution/discernibility. It will be appreciated, however, that there could be many other causes of object detection difficulty, such as camera failure/malfunction or noise (e.g., motion blurring or camera lens fogginess). False failure object detections could result in repeated image capture and object detection attempts (i.e., looping) that causes a time delay until the object is eventually detected or until a front collision occurs without the object ever actually being detected. This either delays or prevents the activation of an autonomous emergency braking (AEB) system or another suitable collision avoidance system. As a result, there exists an opportunity for improvement in the relevant art.

Accordingly, vehicle body components comprising retroreflector systems and/or light accent systems are presented. The term “retroreflector” as used herein refers to a device or surface designed to reflect radar waves with decreased or minimal scattering. Retroreflectors are also commonly referred to as retroflectors and cataphotes. The retroreflectors are designed to improve or enhance the detectability of the vehicle by another vehicle's radar-based object detection system because they reflect more signal to its place of origin (reflected radar waves) compared to other reflective objects. In some embodiments, the retroreflectors can be incorporated into existing vehicle body components (grilles, side molding panels, bumpers, trunk lid finishers, etc.). The term “light accent system” as used herein refers to a device designed to generate/emit light waves and/or to reflect light waves (i.e., an optical reflector). In one exemplary implementation, the light accent system comprises both a light wave generation/emitting system and an optical reflector system. The retroreflective and light “patterns” could be designed in a defined manner (e.g., predetermined and thus predefined) and stored in an accessible memory database such that they are recognizable to another vehicle, which could enable that other vehicle to more accurately (e.g., more quickly) control its AEB system, thereby improving the AEB system performance (earlier warning(s), improved/decreased stopping distance, etc.) and potentially avoiding front collisions altogether that would have otherwise occurred. It will be appreciated that the term “autonomous” as used herein refers to both fully autonomous features and semi-autonomous features (e.g., ADAS features) that require at least some driver participation or intervention.

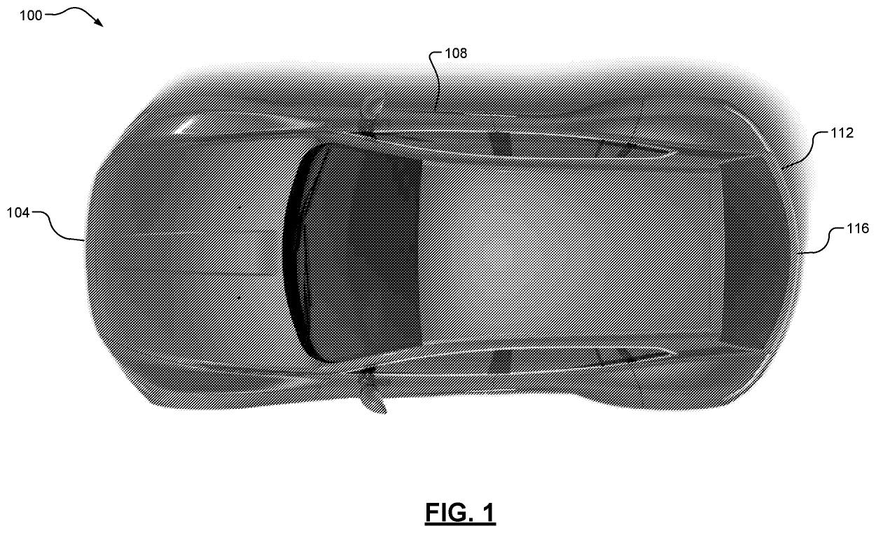

Referring now to FIG. 1, an overhead view of an example vehicle 100 illustrates example body components in which retroreflector systems and/or light accent systems can be implemented. The term “vehicle” as used herein refers to any human-driven or autonomous (self-driving) vehicle, including, but not limited to private and commercial passenger vehicles, such as cars (sedan, coupe, hatchback, convertible, etc.), sport utility vehicles (SUVs), trucks, freight/delivery/hauling vehicles, including articulated trailers, buses, as well as motorcycles, all-terrain vehicles (ATVs), and the like. One example body component in which the retroreflector and/or light accent systems of the present disclosure could be implemented is a front grille 104. Another example body component could be a side molding panel 108. Yet other example body components could be a rear bumper 112 and/or a trunk lid finisher 116 (e.g., a bottom portion of a trunk around a rear license plate or a decorative trim piece located near a middle or upper portion of the trunk). It will be appreciated, however, that the retroreflector and/or light accent systems of the present disclosure could be implemented in any suitable body components (e.g., a front bumper). The term “radar” as used herein comprises any suitable surveying method in a particular bandwidth assigned for passenger vehicles. Passenger vehicle radar and lidar systems, for example, utilize the 76-81 gigahertz (GHz) frequency band, which is very high compared to other systems. The high frequency signals being transmitted and reflected may also require unique design solutions (e.g., very small retroreflector units).

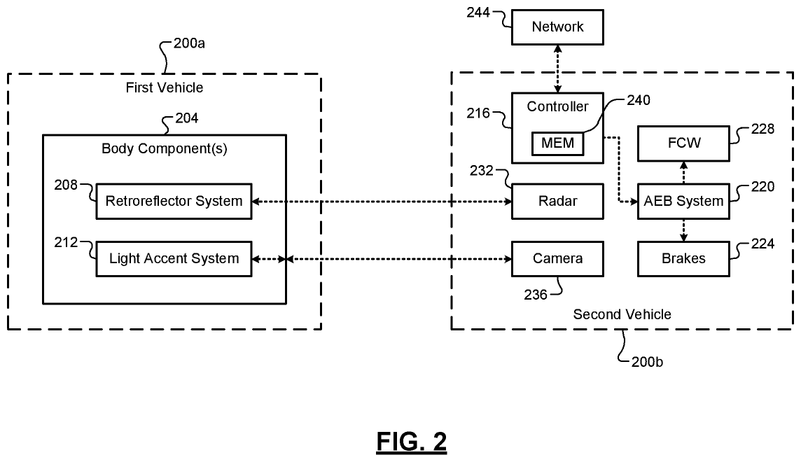

Referring now to FIG. 2, functional block diagrams of two example vehicles 200a, 200b each incorporating at least some aspects of the present disclosure are illustrated. It will be appreciated that vehicles 200a and/or 200b could have a configuration similar to vehicle 100 (described above and shown in FIG. 1) or could have any other suitable vehicle configuration as previously described herein. Vehicle 200a specifically comprises a body component (e.g., as described above) having at least one of an integrated retroreflector system 208 and an integrated light accent system 212. Vehicle 200b, on the other hand, comprises a controller 216 that is configured to activate/control an AEB system 220 for autonomous actuation of a brake system 224 to slow/stop the vehicle 200b and, in some cases, output of a forward collision warning (FCW) 228. The FCW 228 could be a visual output, an audio output, a haptic output, or some combination thereof. The controller 216 also processes reflected radar waves, transmitted/received by radar 232 (e.g., a radar transceiver) and processes emitted and/or reflected light waves using a camera 236 or other suitable light sensing system. The reflected radar waves are associated with a defined retroreflective pattern due to their interaction with the retroreflector system 208. The term “retroreflective pattern” as used herein refers to radar wave strength modulation as well as other radar wave modulations (e.g., phase modulation), which is described in greater detail below, as well as combinations thereof.

The controller 216 also accesses either an internal memory 240 and/or an external memory via a network 244 in order to access a memory database that stores defined retroreflective and/or light patterns (described in greater detail below). This memory database serves as a way for the controller 216 to match a sensed retroreflective and/or light pattern to a known pattern, which could then be leveraged to determined whether or not a vehicle, a pedestrian, or another unique object is in front of the vehicle 200b. Separate from the reflected radar waves, the light waves are generated/emitted by the light accent system 212 or are reflected by the light accent system 212 (e.g., optical reflectors) and are similarly associated with a defined light pattern. The term “light pattern” as used herein refers to a pattern of light waves (e.g., shapes formed by the light waves) as seen in a captured image. It will be appreciated that different defined patterns could be associated with generated/emitted light waves compared to reflected light waves. In one example, the outer portion of headlights and/or taillights could be illuminated and could be identified as two circles/ellipses, two squares/rectangles, or the like. In another example, a grille assembly could be illuminated, either about its perimeter or within its griller bars, to create a unique shape or series of lines. Light accents could also be implemented in places where lights are not normally found on a vehicle and could be implemented and utilized only for the purposes of better identifying the vehicle to other vehicles for better autonomous or ADAS feature operation. Ideally, the light pattern should be at least somewhat unique in that other vehicles/objects would not emit/reflect a similar light pattern.

As discussed above, the retroreflector system 208 reflects radar waves (e.g., from radar 232) such that the reflected radar waves are more distinguishable (e.g., have a greater signal strength compared to reflected radar waves off of other materials). It will be appreciated that the retroreflector system 208 could comprise single unit corner or planar retroreflectors (each, “a retroreflective unit”) or an array geometry comprising one or a plurality of retroreflective units. Array geometry retroreflectors refer to arrays comprising at least one retroreflector unit but up to as many as desired. Each retroreflective unit is formed of a reflective material (e.g., a metal) that is applied (e.g., printed) onto or molded into a substrate (e.g., the body component 204). While printing is described herein, it will be appreciated that other techniques could be utilized, such as applying a film having the retroreflectors disposed or printed thereon. For configurations having a plurality of retroreflective units can be interconnected (e.g., via wire traces) in various manners to achieve various functionality. One non-limiting example is a patch or patchwork configuration. This type of configuration will typically have at least four retroreflective units or “patches” of retroreflective material, and additional ones can be added in even pairs. Uneven lengths could be implemented to cause a phase shift of the reflected radar waves (e.g., in integer multiples of its wavelength). The antenna arrays can also be made longer or shorter, for example, to change the reflected signal distribution in space. Similarly, for example, the antenna arrays can be oriented vertically or horizontally to change the reflected signal distribution. In one exemplary implementation, the retroreflector array is configured as a Van Atta array.

While a strength-based signal reflecting antenna is generally described above, an antenna retroreflector configuration can also be configured such that it causes signal modulation. Some of the example functionality that can be achieved includes: phase shifting, polarization shifting, and creating a unique identifier via modulation of one or more of phase, polarization, frequency, and amplitude of the reflected signal. Non-limiting techniques for achieving this various functionality for a signal modulating antenna retroreflector include: patch and antenna wire lengths, patch and antenna design (number of patches, number of arrays, etc.), wire trace design, oscillators along the wire traces, filters along the wire traces, amplifiers along the wire traces, and physical patterns of the wire traces. These can each be referred to as a modulation device. In some implementations, when implementing modulation devices, small circuits can be added (e.g., printed). Non-limiting examples of the manufacturing methods for these components include printed electronics, film, and in-mold electronics. It will be appreciated that this modulation of the reflected radar waves can be indicative of the defined retroreflective pattern as described herein. For example, the defined retroreflective pattern may indicate a specific signature or unique identifier in the reflected radar waves that could act as a vehicle identification tag for helping the controller 216 distinguish between vehicles and other objects. Even further, signal modulating retroreflective arrays could be utilized for communicating other information between vehicles.

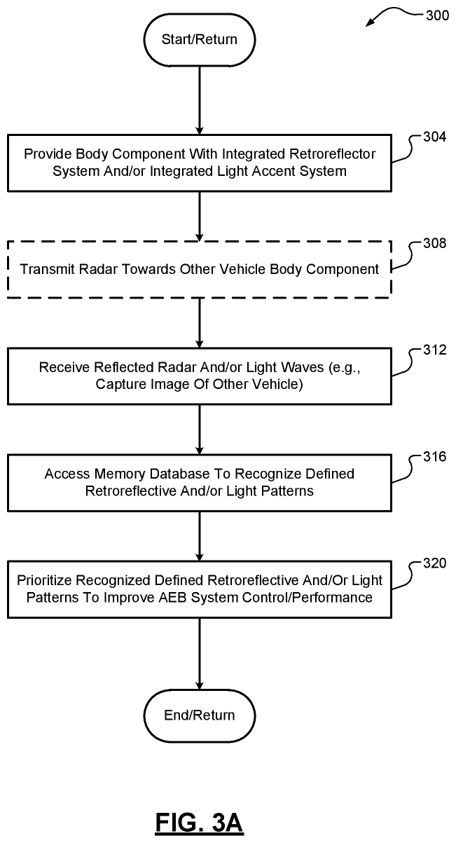

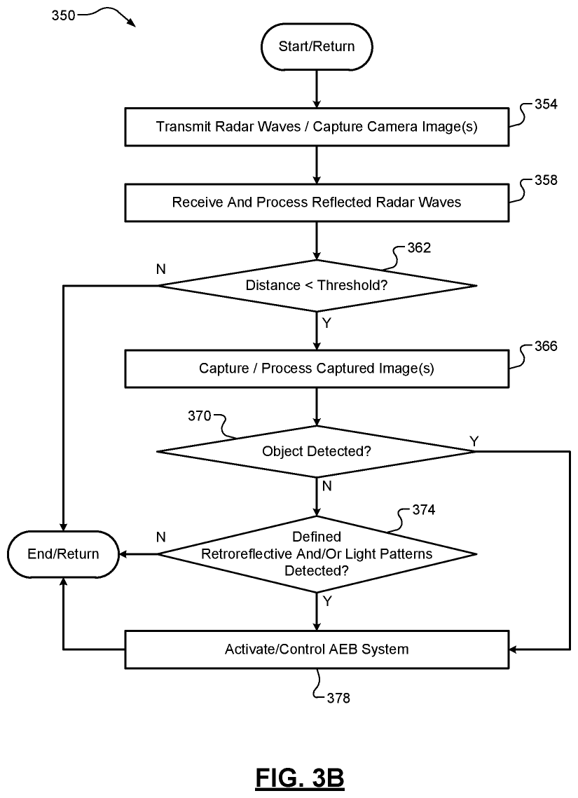

Referring now to FIGS. 3A-3B, flow diagrams of example methods 300, 350 of interaction between a first vehicle having a body component with an integrated retroreflector system and/or an integrated light accent system and interaction therewith by a second vehicle having an autonomous driving system is illustrated. For discussion purposes only, vehicles 200a and 200b and their respective components will be specifically referenced in describing methods 300, 350. It will be appreciated, however, that these methods 300, 350 are applicable to any suitable vehicles having the requisite componentry. For method 300 in FIG. 3A, the body component 204 of vehicle 200a is first obtained, which has at least one of the integrated retroreflector system 208 and the integrated light accent system 212. At 308, radar waves are optionally transmitted from radar device 232 of vehicle 200b towards the body component 204 of vehicle 200a. This step is described as optional because in some implementations the method 300 could be only based on light accent system emission/reflection(s). At 312, vehicle 200b receives the reflected radar waves and/or the light waves from vehicle 200a. This could include, for example, the camera 236 capturing an image of the vehicle 200a including the light waves. At 316, the controller 216 of vehicle 200b accesses the memory database (e.g. locally at memory 240, remotely via network 244, or some combination thereof) and attempts to match the defined retroreflective and/or light patterns to stored patterns. At 320, the controller 216 prioritizes in a decision hierarchy any recognized (matched) defined retroreflective and/or light patterns over other detection criteria to improve control and performance of the AEB system 220. In other words, the recognized/matched defined patterns could be given a higher priority in the decision factor hierarchy of the controller 216 for AEB system control such that, when the controller 216 does not detect the vehicle 200a in an image captured by the camera 236, the controller 216 remains capable of activating the AEB system 220 when at least one of the defined retroreflective and light patterns are recognized/matched. The method 300 then ends or returns to 304 for one or more additional cycles.

For method 350 of FIG. 3B, at 354 the radar 232 initially transmits radar waves towards vehicle 200a. Also at 354, the camera 236 may also capture one or more image(s). At 358, the radar 232 receives and the controller 216 processes the reflected radar waves (e.g., off of retroreflector system 208 of vehicle 200a). This processing could involve, for example, determining a distance to the source/reflecting object, and could also include determining a retroreflective pattern defined by the reflected radar waves. At 362, when the distance is less than a threshold distance indicative of a potential front collision, the method 350 proceeds to 366. Otherwise, the method 350 ends or returns to 354. At 366, the camera 236 captures the image(s) (if not done previously at 354) and processes the captured image(s) for object detection (e.g., using image models), and could also include determining a light pattern defined by the light waves (e.g., emitted from and/or reflected by the light accent system 212). While described sequentially, it will be appreciated that the radar and camera image processing could at least partially overlap (e.g., in parallel). At 370, the controller 216 determines whether an object is detected using the image models (e.g., greater than a confidence threshold that a detected object is another vehicle, a pedestrian, or the like). When true, the method 350 proceeds to 378 where the controller 216 activates/controls the AEB system 220 and/or another suitable collision avoidance system to avoid a front collision of the vehicle 200b. When false, however, the method 350 proceeds to 374. At 374, the controller 216 determines whether the retroreflective and/or light patterns match any stored defined patterns indicative of another vehicle (e.g., vehicle 200a). When false, the method 350 ends or returns to 350. When true, however, the method 350 proceeds to 378 and AEB system 220 activation/control can still be performed without the image model-based object detection having detected anything, thereby improving the accuracy and performance of the AEB system 220. The method 350 then ends or returns to 354 for one or more additional cycles.

According to some aspects of the present disclosure, computer-executable instructions (e.g., software) are executable by one or more processors of the controller 216. First, the controller 216 can be configured to process/analyze the reflected radar waves (amplitude, phase, etc.) and the light waves (e.g., image processing) to determine a retroreflector pattern and/or a light pattern, which the controller 216 can then attempt to match to one of the stored defined patterns. Upon detecting a match, the controller 216 is able to more accurately identify the source of the reflected radar waves and/or the light pattern (e.g., the first vehicle 200a). In response to detecting that the source is another vehicle (e.g., the first vehicle 200a), the controller 216 is configured to output one or more control signals to perform one or more autonomous or ADAS features. This could include, for example, outputting a control signal for the AEB system 220, which could cause the AEB system 220 to autonomously apply the brakes accordingly (e.g., based on a strength of the control signal). It will be appreciated that the controller 216 could also generate control signal(s) for other vehicle systems, such as a vehicle steering system or acceleration system in order to autonomously steer and/or accelerate the vehicle away from a front collision. A control signal for the steering system could actuate a steering motor, whereas a control signal for the acceleration system could increase the torque output of an engine and/or an electric motor of the vehicle powertrain. It will also be appreciated that the controller 216 could output one or more driver notifications, such as audio output, visual output, and/or haptic output, to notify the driver of the autonomous procedure(s) that are occurring and/or to attempt to get the driver's attention so he/she could potentially intervene and assist with avoiding the front collision.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A body component of a first vehicle, the body component comprising at least one of:
(i) an integrated retroreflector system configured to reflect radar waves from a second vehicle according to a predefined retroreflective pattern; and
(ii) an integrated light accent system configured to generate and emit light waves according to a defined light pattern,
wherein receipt of at least one of the reflected radar waves and the light waves by the second vehicle causes a controller of the second vehicle to:
recognize, by accessing a memory database, at least one of the defined retroreflective and light patterns; and
in response to recognizing at least one of the defined retroreflective and light patterns, more accurately control an autonomous emergency braking (AEB) system of the second vehicle to thereby improve the performance of the AEB system.

2. The body component of claim 1, wherein at least one of the defined retroreflective and light patterns is a higher priority than image-based object detection in decision factor hierarchy of the controller for AEB system control.

3. The body component of claim 2, wherein at least one of the defined retroreflective and light patterns is a higher priority in the decision factor hierarchy of the controller for AEB system control such that, when the controller does not detect the first vehicle in an image captured by a camera of the second vehicle, the controller remains capable of activating the AEB system when at least one of the defined retroreflective and light patterns are recognized.

4. The body component of claim 1, wherein the improved performance of the AEB system includes an earlier forward collision warning (FCVV).

5. The body component of claim 1, wherein the improved performance of the AEB system includes a decreased stopping distance.

6. The body component of claim 1, wherein:
the light accent system further comprises one or more optical reflectors configured to reflect light according to a defined reflective pattern;
the controller is configured to recognize, by accessing the memory database, the defined reflective pattern; and
in response to recognizing the defined reflective pattern, more accurately control and thereby improve the performance of the AEB system.

7. A body component for a first vehicle, the body component comprising:
an integrated retroreflector system configured to reflect radar waves from a second vehicle according to a defined retroreflective pattern; and
an integrated light accent system configured to generate and emit light waves according to a defined light pattern,
wherein receipt of the reflected radar waves and the light waves by the second vehicle causes a controller of the second vehicle to:
recognize, by accessing a memory database, the defined retroreflective and light patterns; and
in response to recognizing the defined retroreflective and light patterns, more accurately control an autonomous emergency braking (AEB) system of the second vehicle to thereby improve the performance of the AEB system.

8. The body component of claim 7, wherein the defined retroreflective and light patterns are higher priorities than image-based object detection in decision factor hierarchy of the controller for AEB system control.

9. The body component of claim 8, wherein the defined retroreflective and light patterns are higher priorities in the decision factor hierarchy of the controller for AEB system control such that, when the controller does not detect the first vehicle in an image captured by a camera of the second vehicle, the controller remains capable of activating the AEB system when the defined retroreflective and light patterns are recognized.

10. The body component of claim 7, wherein the improved performance of the AEB system includes an earlier forward collision warning (FCW).

11. The body component of claim 7, wherein the improved performance of the AEB system includes a decreased stopping distance.

12. The body component of claim 7, wherein:
the light accent system further comprises one or more optical reflectors configured to reflect light according to a defined reflective pattern;
the controller is configured to recognize, by accessing the memory database, the defined reflective pattern; and
in response to recognizing the defined reflective pattern, more accurately control and thereby improve the performance of the AEB system.

13. A method of more accurately controlling and thereby improving the performance of an autonomous emergency braking (AEB) system of a first vehicle, the method comprising:
providing a body component of a second vehicle, the body component comprising at least one of (i) an integrated retroreflector system configured to reflect radar waves from the first vehicle according to a defined retroreflective pattern and (ii) an integrated light accent system configured to generate and emit light waves according to a defined light pattern; and
providing a memory database storing information relative to at least one of the defined retroreflective and light patterns,
wherein receipt of at least one of the reflected radar waves and the light waves by the first vehicle causes a controller of the first vehicle to:
recognize, by accessing the memory database, at least one of the defined retroreflective and light patterns; and
in response to recognizing at least one of the defined retroreflective and light patterns, more accurately control and thereby improve the performance of the AEB system.

14. The method of claim 13, wherein at least one of the defined retroreflective and light patterns is a higher priority than image-based object detection in decision factor hierarchy of the controller for AEB system control.

15. The method of claim 14, wherein at least one of the defined retroreflective and light patterns is a higher priority in the decision factor hierarchy of the controller for AEB system control such that, when the controller does not detect the second vehicle in an image captured by a camera of the first vehicle, the controller remains capable of activating the AEB system when at least one of the defined retroreflective and light patterns are recognized.

16. The method of claim 13, wherein the improved performance of the AEB system includes an earlier forward collision warning (FCW).

17. The method of claim 13, wherein the improved performance of the AEB system includes a decreased stopping distance.

18. The method of claim 13, wherein:
the light accent system further comprises one or more optical reflectors configured to reflect light according to a defined reflective pattern;
the controller is configured to recognize, by accessing the memory database, the defined reflective pattern; and
in response to recognizing the defined reflective pattern, more accurately control and thereby improve the performance of the AEB system.

19. The method of claim 13, wherein:
the body component of the second vehicle comprises both (i) the integrated retroreflector system and (ii) the integrated light accent system;
receipt of the defined retroreflective and light patterns causes the controller to recognize, by accessing the memory database, both the defined retroreflective and light patterns; and
in response to recognizing both the defined retroreflective and light patterns, even more accurately control and even further improve the performance of the AEB system.

20. The method of claim 19, further comprising:
transmitting, by a radar system of the first vehicle, the radar waves reflected by the integrated retroreflector system of the body component of the second vehicle;
capturing, by a camera of the first vehicle, an image; and
identifying, by the controller, the defined light pattern in the captured image.
